(19) United States
(12) Patent Application Publication
(10) Pub. No.: US 2008/0189511 A1
(43) Pub. Date: Aug. 7, 2008

(54) TABLE VALUE CONVERSION DEVICE AND METHOD FOR CONVERTING AND WRITING TABLE VALUE

(76) Inventors: Yuji Watarai, Kasugai (JP); Kunihiro Ohara, Kasugai (JP)

Correspondence Address: ARENT FOX LLP, 1050 CONNECTICUT AVENUE, N.W., SUITE 400, WASHINGTON, DC, 20036, US

(21) Appl. No.: 12/056,036

(22) Filed: Mar. 26, 2008

Related U.S. Application Data
(63) Continuation-in-part of application No. 11/715,315, filed on Mar. 8, 2007.

(30) Foreign Application Priority Data
Mar. 29, 2006 (JP) 2006-091274
Mar. 26, 2007 (JP) 2007-079022

(51) Int. Cl. G06F 12/00

(52) U.S. Cl. 711/217; 711/E12.001

(57) ABSTRACT

A table value conversion device for use with a memory in which a default table value is stored, a central processing unit for reading a default table value from the memory and outputting an output value, and a functional macro functioning as hardware for processing data and storing a lookup table. The device enables simple and efficient rewriting of values stored in the memory. The device includes a conversion module arranged on an external bus extending between the memory and the central processing unit. The conversion module receives the output value of the central processing unit, performs a correction computation on the received output value to generate a corrected value, and converts a table value of the lookup table in the functional macro based on the corrected value.

### CROSS-REFERENCE TO RELATED APPLICATIONS

This is a continuation-in-part application of U.S. patent application Ser. No. 11/715,315, filed on Mar. 8, 2007, which is based upon and claims the benefit of priority from prior Japanese Patent Application No. 2006-091274, filed on Mar. 29, 2006, and Japanese Patent Application No. 2007-079022, filed on Mar. 26, 2007. The contents of the prior applications are incorporated herein by reference.

### BACKGROUND

1. Field

The embodiment relates to improvements in a device and method for converting values in a table memory stored as a lookup table.

2. Description of the Related Art

Electronic devices, such as an electronic camera, a digital copying machine, and a laser printer, normally include an image processor for converting digital image data. A typical image processor has a table memory that uses a lookup table (LUT). The lookup table of the table memory may store table values, such as color correction values. The image processor converts image data based on a table value stored in the lookup table of the table memory and performs color correction on the data to generate corrected image data. More specifically, the image processor accesses the table memory at an address of the original image data, reads a table value corresponding to that address from the table memory, and performs color correction on the original image data in accordance with the read table value.

In a conventional image processor performing color correction with the LUT table memory, table values stored in the table memory may be rewritten when performing image characteristics correction, such as gamma correction, contrast correction, and chroma correction. Methods for rewriting the table memory in the conventional image processor is described with reference to FIGS. 1(a), 1(b), and 1(c).

In the case of a first conventional method shown in FIG. 1(a), a ROM 60 includes a plurality of table memories TM respectively corresponding to various image characteristics. For example, to enhance contrast, a CPU 61 reads data from the table memory TM of the ROM 60 that corresponds to the contrast characteristic. The CPU 61 then rewrites the data of an LUT 63 for a macro 62 based on values of the read table memory TM (Japanese Laid-Open Patent Publication No. 6-70165).

In the case of a second conventional method shown in FIG. 1(b), a ROM 60 includes a reference table memory STM. A CPU 64 reads table values from the reference table memory STM, corrects the table values, and rewrites an LUT 63 for a macro 62 based on the corrected table values (Japanese Laid-Open Patent Publication No. 6-133158).

In the case of a third conventional method shown in FIG. 1(c), a computer 65, which is for use exclusively with a macro 62 of an LUT 63, performs predetermined computation with image data output via the LUT 63 to enable required processing of the obtained image data such as correction and enhancement.

With the above-described conventional methods, the table values stored in the LUT table memory are rewritten or computed to ensure that various corrections or the like of the obtained image data are performed.

### SUMMARY

The embodiment provides a table value conversion device including an external bus extending between a memory configured to store a default table value and a central processing unit reading the default table value from the memory and outputting an output value, and a conversion module arranged on the external bus in which the conversion module receives the output value of the central processing unit, performs a correction computation on the received output value to generate a computation value, and converts a table value of the lookup table in a functional macro functioning as hardware for processing data and storing a lookup table based on the computation value.

### BRIEF DESCRIPTION OF THE DRAWINGS

The embodiment, together with objects and advantages thereof, may best be understood by reference to the following description of the presently preferred embodiments together with the accompanying drawings in which:

FIGS. 1(a), 1(b), and 1(c) are block diagrams of conventional table value conversion devices;

FIG. 2 is a block diagram of a table value conversion device according to a first embodiment;

FIG. 3 is a block diagram of a conversion module in the table value conversion device of FIG. 2; and

FIG. 4 is a flowchart showing the procedures for converting and writing table values in the first embodiment

FIG. 5 is a block diagram of a conversion module according to a second embodiment;

FIG. 6 is an address map of the second embodiment;

FIG. 7 is a schematic diagram showing table value conversion in the second embodiment;

FIG. 8 is a block diagram of a conversion module according to a third embodiment;

FIG. 9 is a schematic diagram showing table value conversion of the third embodiment;

FIG. 10 is a flowchart showing the procedures for setting correction coefficients in the third embodiment;

FIG. 11 is a block diagram of a table value conversion device according to a fourth embodiment;

FIG. 12 is a block diagram of a conversion module in the fourth embodiment; and

FIG. 13 is a block diagram of a reverse conversion module in the fourth embodiment.

### DETAILED DESCRIPTION OF THE EMBODIMENTS

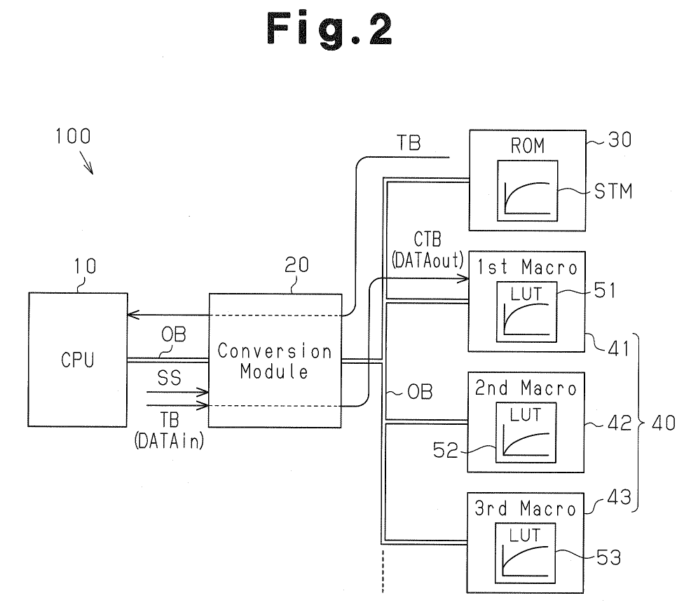

A table value conversion device and a method for converting and rewriting a table value according to a first embodiment will now be described with reference to FIGS. 2 to 4.

As shown in FIG. 2, a table value conversion device 100 of the first embodiment includes a central processing unit (CPU) 10, a conversion module 20 arranged along an external bus OB of the CPU 10, and a ROM 30 and macros 40 that are commonly connected to the external bus OB.

The CPU 10 centrally controls processing relating to image processing. For example, based on digital image data or the like obtained by, for example, an image acquisition device, the CPU 10 provides the macros 40 (to be accurate, a single macro designated by the CPU 10) with a conversion command for converting the data or with a table value conversion and writing command.

The macros 40 are hardware for performing data processing such as image processing. In the first embodiment, the macros 40 may be formed by a first macro 41, a second macro 42, and a third macro 43. The macros 41 to 43 respectively include LUTs 51, 52, and 53. The LUTs 51, 52, and 53 differ from one another in their characteristics. When provided with a conversion command and data (value) from the CPU 10, each of the macros 41 to 43 converts the provided data by referring to the corresponding LUT.

The conversion module 20 is arranged along the external bus OB between the macros 41 to 43 and the CPU 10. The conversion module 20 has computation functions such as multiplication, addition, and clipping. When converting and writing table values of the LUTs 51 to 53, the conversion module 20 aids the processing performed by the CPU 10. More specifically, when converting and writing a table value, the CPU 10 reads a default table value used for rewriting an LUT, that is, a table value TB from a reference table memory STM of the ROM 30 that is commonly connected to the external bus OB. The CPU 10 then provides the conversion module 20 with the read table value TB via the external bus OB. Before reading the table value, the CPU 10 provides the conversion module 20 with a setting signal SS, and sets or registers conversion parameters used for correction computation of the table value TB in the conversion module 20. Examples of the conversion parameters include a multiplication coefficient (multiplication value) M, an addition constant (addition value) A, an upper limit clip value H, and a lower limit clip value L. Based on the registered conversion parameters, the conversion module 20 performs a computation to correct the table value TB and generate a corrected table value CTB. The conversion module 20 then provides the macro designated by the CPU 10 with the corrected table value CTB. This updates or rewrites the LUT of the designated macro with the corrected table value CTB.

As described above, in the first embodiment, the conversion module 20 arranged on the external bus OB of the CPU 10 substantially converts the table value. The CPU 10 simply reads the default table value TB from the reference table memory STM of the ROM 30 and outputs the default table value TB to the external bus OB. The output table value TB is converted by the correction computation of the conversion module 20. Then, the converted value resulting is written to the LUT of the designated macro.

In the first embodiment, when the CPU 10 reads the table value TB from the ROM 30, the conversion module 20 transfers the table value TB read from the ROM 30 to the CPU 10 without converting the table value TB. When the LUT for the macro 40 is referenced and normal data conversion (image processing) is performed, the conversion module 20 does not perform the conversion operation. That is, the processing of the conversion module 20 is skipped.

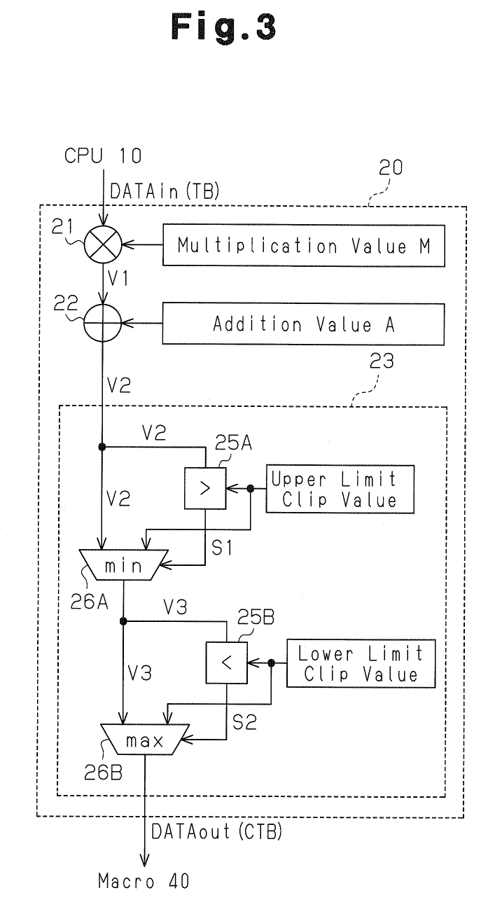

A correction computation circuit of the conversion module 20 that converts table values and the correction computation performed by the correction computation circuit will now be described with reference to FIG. 3.

In the conversion module 20, the correction computation circuit includes a multiplier 21, an adder 22, and a clip circuit 23. The conversion module 20 receives a setting signal SS from the CPU 10. The multiplier 21 receives a multiplication coefficient M, which is a conversion parameter registered in a register or the like based on the setting signal SS. The conversion module 20 receives a table value TB output from the CPU 10 as input data DATAin. The multiplier 21 multiplies the input data DATAin by the multiplication coefficient M and outputs a computation value V1, resulting from the multiplication, to the adder 22. The adder 22 receives an addition constant A, which is a conversion parameter registered in a register or the like based on the setting signal SS. The adder 22 adds the addition constant A to the computation value V1 and provides a computation value V2, resulting from the addition, to the clip circuit 23.

The clip circuit 23 includes a first comparator 25A, a second comparator 25B, a first selection circuit 26A, and a second selection circuit 26B. The computation value V2 of the adder 22 is provided to both the first comparator 25A and the first selection circuit 26A. The first comparator 25A is provided with the computation value V2 input from the adder 22 as well as an upper limit clip value H, which is a conversion parameter set in a register or the like based on the setting signal SS. The first comparator 25A compares the computation value V2 with the upper limit clip value H to provide the first selection circuit 26A with a comparison result signal S1 indicating whether the computation value V2 is greater than the upper limit clip value H. The first selection circuit 26A is also provided with the computation value V2 and the upper limit clip value H in the same manner as the first comparator 25A. The first selection circuit 26A selects the smaller one of the computation value V2 and the upper limit clip value H based on the comparison result signal S1 received from the first comparator 25A to output the selected value. For example, when the computation value V2 is smaller than the upper limit clip value H, the first selection circuit 26A selectively outputs the computation value V2 as an output value V3. When the upper limit clip value H is smaller than the computation value V2, the first selection circuit 26A selectively outputs the upper limit clip value H as the output value V3. The output value V3 of the first selection circuit 26A is provided to both the second comparator 25B and the second selection circuit 26B. The second comparator 25B is provided with the output value V3 as well as a lower limit clip value L, which is a conversion parameter set in a register or the like based on the setting signal SS. The second comparator 25B compares the output value V3 of the first selection circuit 26A with the lower limit clip value L to provide the second selection circuit 26B with a comparison result signal S2 indicating whether the output value V3 is smaller than the lower limit clip value L. The second selection circuit 26B is also provided with the output value V3 of the first selection circuit 26A and the lower limit clip value L in the same manner as the second comparator 25B. The second selection circuit 26B selects a greater one of the output value V3 and the lower limit clip value L based on the comparison result signal S2 received from the second comparator 25B to output the selected value. For example, when the output value V3 of the first selection circuit 26A is greater than the lower limit clip value L, the second selection circuit 26B selectively outputs the output value V3 as output data DATAout. When the lower limit clip value L is greater than the output value V3, the second selection circuit 26B selectively outputs the lower limit clip value L as the output data DATAout. The conversion module 20 provides the output data DATAout to the macros 40.

As described above, the conversion module 20 generates the output data DATAout by subjecting the table value TB of the reference table memory STM input from the CPU 10, that is, the input DATAin, to the next correction computation.

DATAout=max(L, min (H, DATAin*M+A)).

In the above equation, max (a, b) is a function for selecting the greater one of values a and b, and min(a,b) is a function for selecting the smaller one of values a and b.

The employment of the conversion module 20 enables table value conversion with a relatively high degree of freedom using parameters including the multiplication coefficient M and the addition constant A. Further, the combined employment of the upper limit clip value H and the lower limit clip value L enables conversion of the input data DATAin while suppressing the occurrence of table values greatly deviating from a predetermined range, such as noise elements. When the default table value TB of the reference memory table STM is directly written to the LUT of a macro 40 without being converted, the CPU 10 sets the conversion module 20 in a manner that the table value TB is directly provided to the macros 40 without being converted.

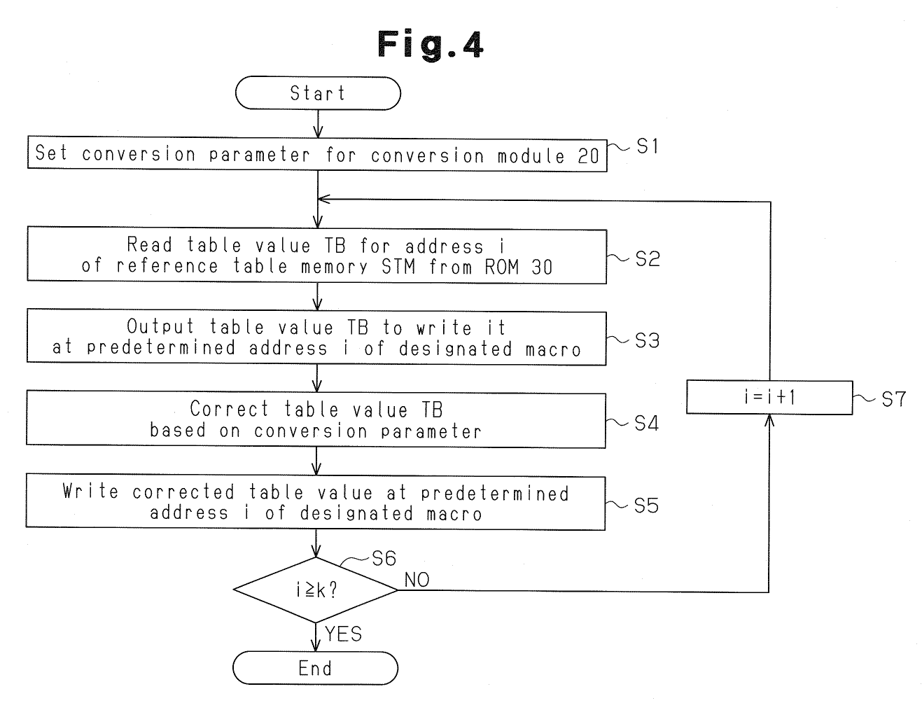

The table value conversion and writing method using the table value conversion device 100 will now be described with reference to FIG. 4. An example in which a table value is converted and written to the LUT 51 of the first macro 41 among the macros 41 to 43 will be described.

When converting a table value and writing the table value to the first macro 41, in operation S1, the CPU 10 provides the conversion module 20 with the setting signal SS. Further, the CPU 10 sets conversion parameters corresponding to the LUT 51 of the first macro 41 for the conversion module 20. That is, the CPU 10 sets the multiplication coefficient M, the addition constant A, the upper limit clip value H, and the lower limit clip value L. The CPU 10 may generate a setting signal SS in accordance with conversion parameters input by, for example, a user. The CPU 10 provides the conversion module 20 with this setting signal SS to set the conversion parameters. Alternatively, the CPU 10 may automatically determine conversion parameters suitable for the present imaging environment or the like. In this case, the CPU 10 generates a setting signal SS in accordance with the determined conversion parameters, and provides the conversion module 20 with this setting signal SS.

In operation S2, the CPU 10 reads a table value TB for one address, that is, from address i of the reference table memory STM in the ROM 30. When, for example, the reference table memory STM of the ROM 30 has table values TB corresponding to addresses 0 to 25, the table values TB are sequentially read from address 0 one after another.

In operation S3, after reading the table value TB for one address in the manner described above, the CPU 10 outputs the read table value TB to the external bus OB to write the read table value TB at the same address i of the first macro 41. More specifically, when the table value TB is read from address 0 of the ROM 30 in operation S2, the CPU 10 outputs the read table value TB to rewrite the table value at address 0 of the LUT 51 in the first macro 41.

In operation S4, the conversion module 20 performs a computation to correct the table value TB output from the CPU 10 based on the conversion parameters set in operation S1. More specifically, the conversion module 20 performs the correction computation described above using the table value TB output from the CPU 10 as the input data DATAin and the corrected table value CTB as the output data DATAout.

In operation 5, after correcting the table value TB, the conversion module 20 outputs the output data DATAout, that is, the corrected table value CTB, to the first macro 41. More specifically, the conversion module 20 writes the corrected table value CTB at the predetermined address i of the LUT 51 in the first macro 41 in accordance with the writing command provided from the CPU 10 in operation S3. This rewrites the table value at address i of the LUT 51 in the first macro 41 with the corrected table value CTB.

Subsequently, in operation S6, the value of address i, which is the address at which the table value is read from the ROM 30 as well as the address at which the table value is written to the LUT 51 in the macro 41, is compared with a total address number k of the reference table memory STM in the ROM 30 and the LUT 51 in the first macro 41. When the value of address i is less than the total address number k, the CPU 10 increments the value of address i in operation S7, and returns to operation S2. The processing in operations S2 to S7 is repeated until the value of address i reaches the total address number k, that is, until the table values at all the addresses are completely rewritten. When the value of address i reaches the total address number k in operation S6, the table value conversion and writing to the LUT 51 of the first macro 41 is terminated. The processing described above ensures that the table values of the LUT 51 in the first macro 41 are each converted.

The first embodiment has the advantages described below.

(1) The conversion module 20 connected between the CPU 10 and the macros 40, that is, arranged on the external bus OB, performs a correction computation on the reference table values TB and writes the corrected table values CTB to the LUT of each macro 40. This enables the single conversion module 20 to convert the table values TB for the LUTs of a plurality of macros and write the corrected table values CTB to the LUTs of the plurality of macros. This reduces the production cost of the image processor and minimizes the capacity of the reference table memory STM stored in the ROM 30. Thus, an increase in the memory capacity is suppressed. Further, the employment of the conversion module 20 significantly reduces the computation load on the CPU 10 and consequently shortens the processing time of the CPU 10. More specifically, the conversion and writing of table values for the LUTs in each macro is efficiently performed with a simple structure.

(2) Based on conversion parameters set by the CPU 10, that is, the multiplication coefficient M, the addition constant A, the upper limit clip value H, and the lower limit clip value L, the conversion module 20 converts the input data DATAin (table value TB) from the CPU 10 to the data DATAout (table value CTB) by performing the correction computation with the next equation.

DATAout=max(L, min(H, DATAin*M+A))

This enables table value conversion with a high degree of freedom using parameters including the multiplication coefficient M and the addition constant A. Further, the combined use of the upper limit clip value H and the lower limit clip value L suppresses the occurrence of table values greatly deviating from a predetermined range, such as noise elements.

(3) The ROM 30 and the macros 41 to 43 are commonly connected to the external bus OB of the CPU 10 via the conversion module 20. This increases the utilization efficiency of the external bus OB. In particular, the ROM 30 is connected to the external bus OB downstream to the conversion module 20. This also increases the design freedom for the entire device.

(4) The conversion module 20 is set so that it does not operate during normal data conversion (image processing) performed using the LUTs 51 to 53. This reduces unnecessary power consumption during normal data conversion (image processing).

The table value conversion and writing method of the first embodiment enables the rewriting of table values for lookup tables in any macros.

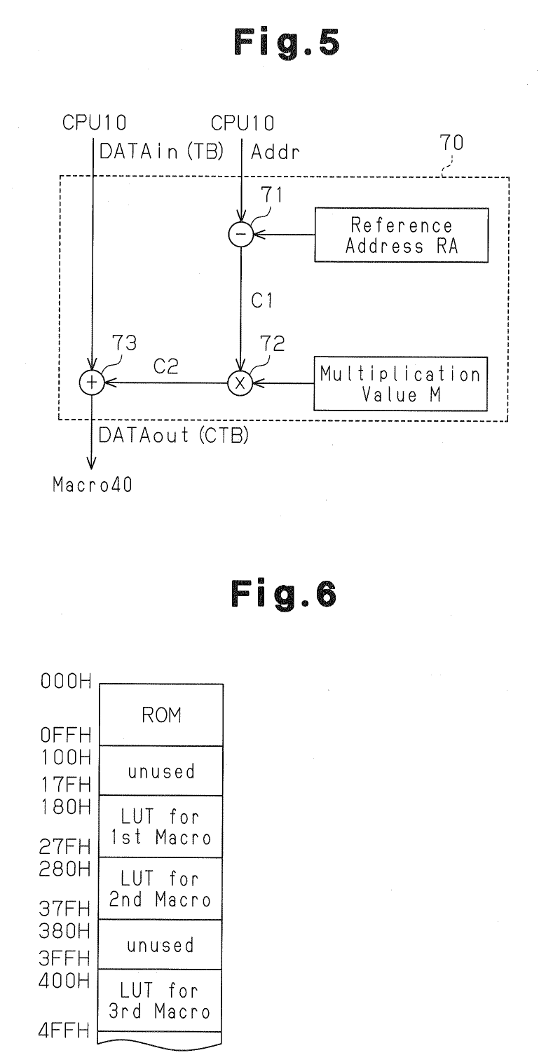

A table value conversion device according to a second embodiment will now be described with reference to FIGS. 5 to 7. The table value conversion device according to the second embodiment includes a conversion module that differs from that of the first embodiment. The differences from the first embodiment will be described below.

In particular, a correction computation circuit that converts table values of a conversion module 70 arranged in the table value conversion device of the second embodiment will be described with reference to FIG. 5. The correction computation circuit of the conversion module 70 basically includes a subtractor 71, a multiplier 72, and an adder 73. The multiplier 72 functions as a second computer. The subtractor 71 receives an address Addr of the LUT of a specific macro designated by the CPU 10 from the CPU 10. The address Addr is a value representing the address of a destination for writing a corrected table value CTB, which is generated by correcting the table value TB input to the conversion module 70, and is, for example, a hexadecimal value.

An address map of the ROM 30 and the macros 40 referenced by the CPU 10 will be described with reference to FIG. 6. Addresses 000H to 0FFH are assigned to the ROM 30. Addresses 180H to 27FH are assigned to the LUT 51 of the macro A41. Addresses 280H to 37FH are assigned to the LUT 52 of the macro B42. Addresses 400H to 4FFH are assigned to the LUT 53 of the macro 43. In the addresses, “H” indicates that the value is a hexadecimal number.

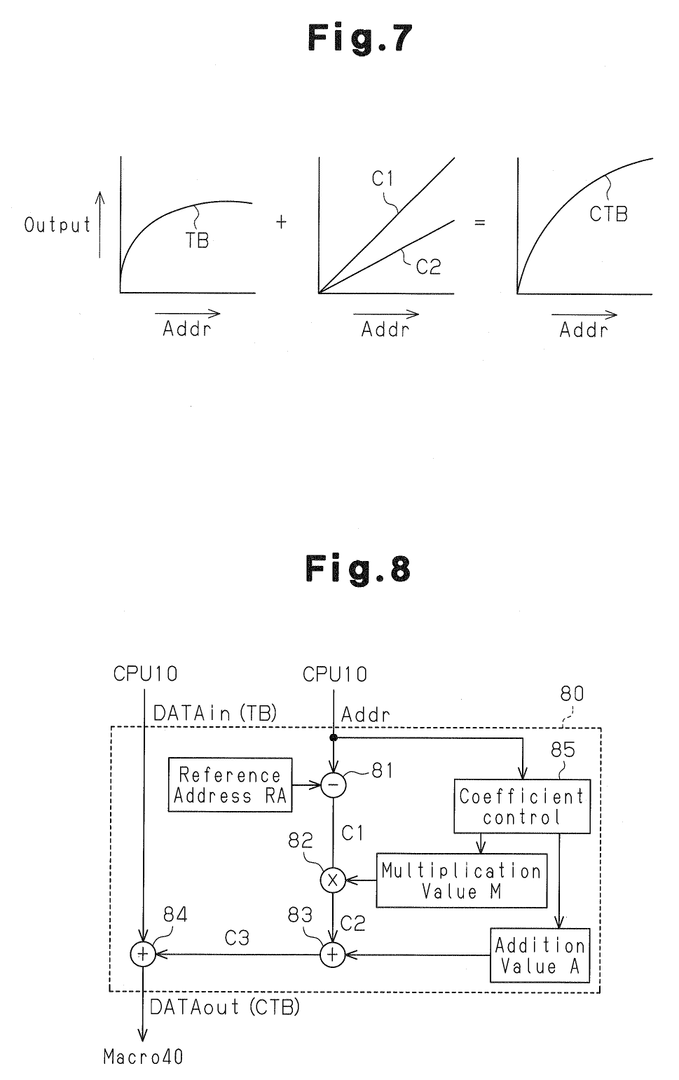

The subtractor 71 receives a reference address RA set by the setting signal SS from the CPU 10. The subtractor 71 subtracts the reference address RA from the address Addr to generate a corrected value C1 and provides the corrected value C1 to the multiplier 72. For example, when the CPU 10 designates the macro A41, the head address 180H of the LUT 51 of the macro A41 is set as the reference address RA. When the CPU 10 designates the macro B42, the head address 280H of the LUT 52 of the macro B42 is set as the reference address RA. When the CPU 10 designates the macro C43, the head address 400H of the LUT 53 of the macro C43 is set as the reference address RA. That is, as shown in FIG. 7, when the head address of the LUT of each macro 40 is input to the conversion module 70 as the address Addr, the reference address RA is set so that the corrected value C1 becomes “0”. The corrected value C1 becomes the address in the LUT of a specific macro designated by the CPU 10. The value of the address in the LUT is increased by one whenever the address Addr input from the CPU 10 is increased from the head address by one address.

The multiplier 72 receives the corrected value C1 and a multiplication value M. The multiplication value M is one of the conversion parameters set by the setting signal SS from the CPU 10. The multiplier 72 multiplies the corrected value C1 by the multiplication value M to generate a corrected value C2 (see FIG. 7) and provides the corrected value C2 to the adder 73.

The input data DATAin, which is the table value TB of the reference table memory STM (see FIG. 7), is provided from the CPU 10 to the adder 73. The adder 73 adds the corrected value C2 to the input data DATAin to generate a computation value and outputs the computation value to a predetermined address of the LUT of a specific macro as output data DATAout of the conversion module 70. That is, the adder 73 outputs the corrected table value CTB to the address Addr of the LUT designated by the CPU 10. The table value of the address Addr of the LUT designated by the CPU 10 is thus rewritten to the corrected table value CTB.

The conversion module 70 generates the output data DATAout by performing the correction computation on the table value TB of the reference table memory STM input from the CPU 10, that is, the input data DATAin.

DATAout=DATAin+{(Addr−RA)×M} (2)

The table value is converted with a high degree of freedom since the multiplication value M is used. Furthermore, the table value TB of the reference table memory STM may be converted using the corrected value C2 having different values for each address since the address Addr and the reference address RA are simultaneously used.

The second embodiment has the advantage described below in addition to advantages (1, (3), and (4) of the first embodiment.

(5) The conversion module 70 performs a predetermined computation (subtraction and multiplication in the present example) on the address Addr received from the CPU 10. The corrected value C2 (see FIG. 7) having different values for each address is thus easily generated for the table value TB (LUT of specific macro) of the reference table memory STM. The employment of the corrected value {=(Addr−RA)×M} enables the table value to be converted with high degree of freedom. This, in turn, enables the table value conversion in accordance with the content of each macro 40.

For example, when arranging an exclusive counter and changing the conversion parameters based on the count value of the counter, corrected values having different values for each address may be generated for the table value TB of the reference table memory STM. However, cost increase would be inevitable since the exclusive counter or the like is necessary. Comparatively, in the second embodiment, increase in cost is suppressed since a computer for performing a predetermined computation on the address Addr originally output from the CPU 10 merely needs to be added in the conversion module 70 of the second embodiment.

A table value conversion device according to a third embodiment will now be described with reference to FIGS. 8 to 10. The table value conversion device of the third embodiment includes a conversion module that differs from that of the first embodiment. The differences from the first embodiment will be described below.

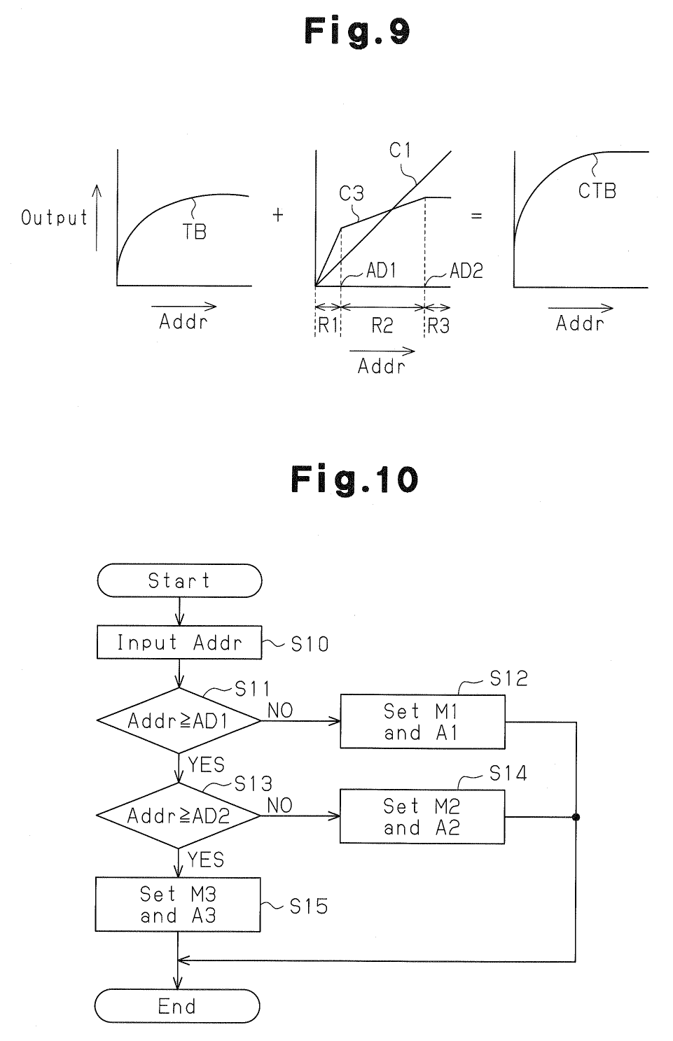

In particular, a correction computation circuit that converts table values of a conversion module 80 arranged in the table value conversion device of the third embodiment will be described with reference to FIG. 8. The correction computation circuit of the conversion module 80 basically includes a subtractor 81, a multiplier 82, an adder 83, an adder 84, and a coefficient control circuit 85. The subtracter 81 receives an address Addr of the LUT of a specified macro designated by the CPU 10 from the CPU 10. The subtracter 81 receives a reference address RA set by a setting signal SS from the CPU 10. The subtracter 81 subtracts the reference address RA from the address Addr to generate a corrected value C1 (see FIG. 9) and provides the corrected value C1 to the multiplier 82.

The address Addr is also provided to the coefficient control circuit 85. The coefficient control circuit 85 sets a multiplication value M and an addition constant A corresponding to the address Addr. The multiplication value M and the addition constant A are examples of correction coefficients.

Specifically, the entire LUT is divided into a plurality of (three in the present example) regions R1, R2, and R3 in the third embodiment (see FIG. 9). The coefficient control circuit 85 sets the multiplication value M and the addition constant A for each of regions R1, R2, and R3. In one example, the coefficient control circuit 85 sets the multiplication value M to a first multiplication value M1 and the addition constant A to a first addition constant A1 when the address Addr is in region R1. The coefficient control circuit 85 sets the multiplication value M to a second multiplication value M2 and the addition constant A to a second addition constant A2 when the address Addr is in region R2. The coefficient control circuit 85 sets the multiplication value M to a third multiplication value M3 and the addition constant A to a third addition constant A3 when the address Addr is in region R3. The multiplication values M1, M2, and M3 are individually determined and may differ from each other. The addition constants A1, A2, and A3 are individually determined and may differ from each other.

The multiplier 82 receives the multiplication value M (first to third multiplication values M1 to M3) set by the coefficient control circuit 85 in accordance with the address Addr. The multiplier 82 multiplies the corrected value C1 by the multiplication value M to generate the corrected value C2 and provides the corrected value C2 to the adder 83.

The adder 83 receives the addition constant A (first to third addition constants A1 to A3) set by the coefficient control circuit 85 in accordance with the address Addr. The adder 83 adds the addition constant A to the corrected value C2 to generate a corrected value C3 and provides the corrected value C3 to the adder 84. As shown in FIG. 9, the inclination of a line representing the corrected value C3 differs for each of regions R1 to R3.

The adder 84 adds the corrected value C3 to the table value TB (FIG. 9), that is, the input data DATAin to generate a computation value and outputs the computation value to a predetermined address of the LUT of a specific macro as the output data DATAout of the conversion module 80. The output data DATAout is the corrected table value CTB. The table value of the address Addr of the LUT designated by the CPU 10 is rewritten to the corrected table value CTB.

The conversion module 80 generates the output data DATAout by subjecting the table value TB of the reference table memory STM input from the CPU 10, that is, the input data DATAin, to the correction computation (see equation (3) to (5) below) that differs for each of regions R1 to R3. That is, the conversion module 80 executes the correction computation of equation (3) when the address Addr is in region R1, executes the correction computation of equation (4) when the address Addr is in region R2, and executes the correction computation of equation (5) when the address Addr is in region R3.

DATAout=DATAin+{(Addr−RA)×M1+A1} (equation 3)

DATAout=DATAin+{(Addr−RA)×M2+A2} (equation 4)

DATAout=DATAin+{(Addr−RA)×M3+A3} (equation 5)

Since the coefficient control circuit 85 changes the correction coefficient (multiplication value M and addition constant A) for every region R1 to R3, the table value TB may be corrected by the corrected value C3 having different values for every address of the LUT and having different inclinations for each of regions R1 to R3.

A method for setting the correction coefficient (multiplication value M and addition constant A) executed by the coefficient control circuit 85 will now be described.

In operation 10, the coefficient control circuit 85 receives the address Addr from the CPU 10. In operation 11, the coefficient control circuit 85 compares the address Addr and a first comparative address AD1, which is a head address of region R2.

When the coefficient control circuit 85 determines that the address Addr is smaller than the first comparative address AD1 and that the address Addr is in region R1 (NO in operation 11), the coefficient control circuit 85 sets the first multiplication value M1 as the multiplication value M and the first addition constant A1 as the addition constant A in operation 12.

When the address Addr is greater than or equal to the first comparative address AD1 (YES in operation 11), the coefficient control circuit 85 compares the address Addr and a second comparative address AD2, which is a head address of region R3. When the coefficient control circuit 85 determines that the address Addr is smaller than the second comparative address AD2 and that the address Addr is in region R2 (NO in operation 13), the coefficient control circuit 85 sets the second multiplication value M2 as the multiplication value M and the second addition constant A2 as the addition constant A in operation 14.

When the coefficient control circuit 85 determines that the address Addr is greater than or equal to the second comparative address AD2 and that the address Addr is in region R3 (YES in operation 13), the coefficient control circuit 85 sets the third multiplication value M3 as the multiplication value M and the third addition constant A3 as the addition constant A in operation 15.

The third embodiment has the advantage described below in addition to advantages (1), (3), (4), and (5) of the first and second embodiments.

(6) The coefficient control circuit 85 arranged in the conversion module 80 changes the multiplication value M and the addition constant A serving as correction coefficients in accordance with the region to which the address Addr input from the CPU 10 belongs. The region to which the address Addr belongs is easily determined by comparing the address Addr with the boundary addresses of regions R1 to R3, that is, the first comparative address AD1, which is the head address of region R2, and the second comparative address AD2, which is the head address of region R3. The corrected value C1 that changes at a constant inclination as address Addr changes is converted to the corrected value C3 (corrected value C2), the inclination of which changes for each of regions R1 to R3. The corrected value C3 used in the table value conversion is set with high degree of freedom through the use of correction coefficients set for every region R1 to R3. The table value may be converted with a high degree of freedom by using the corrected value C3. The table value may be converted in accordance with the content of each macro 40.

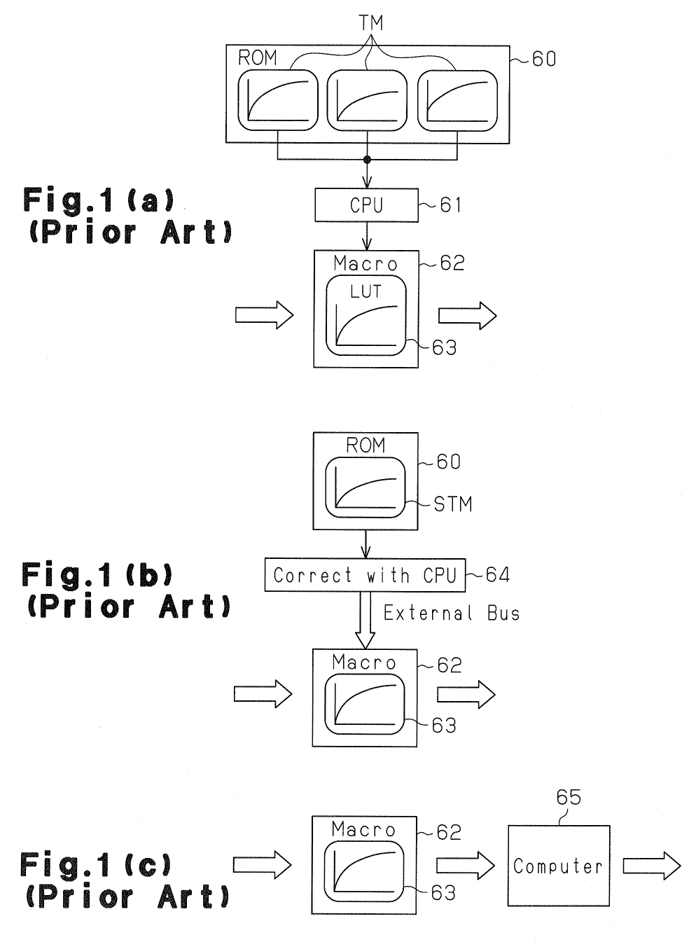

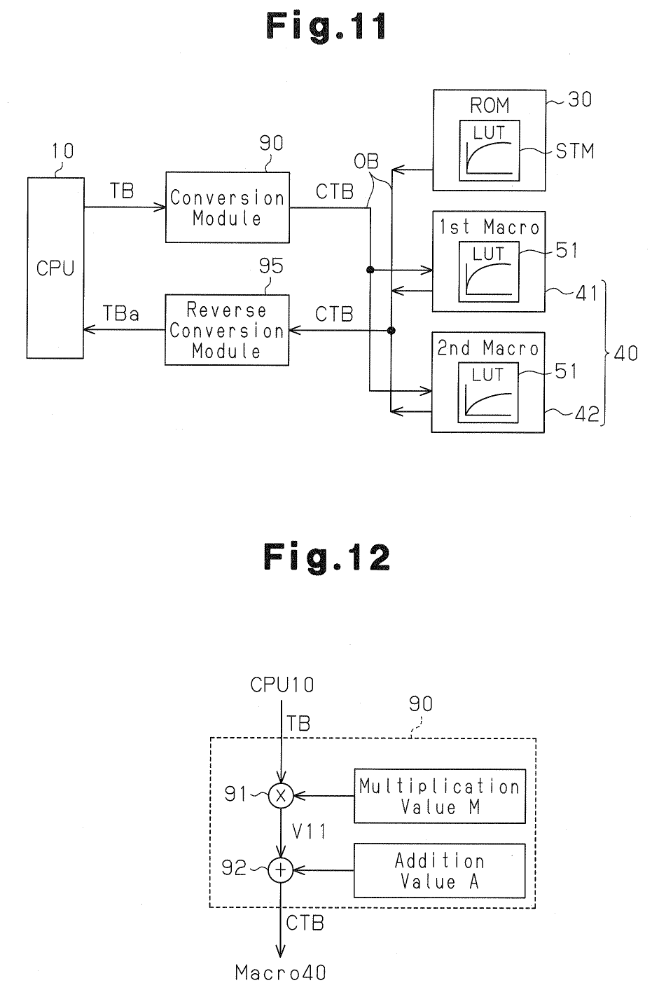

A table value conversion device 200 according to a fourth embodiment will now be described with reference to FIGS. 11 to 13. The same reference numerals are used for members that are the same as those shown in FIGS. 1 to 10 to simplify the description.

As shown in FIG. 11, the table value conversion device 200 includes a CPU 10, a conversion module 90, a reverse conversion module 95, a ROM 30, and macros 40. The conversion module 90 and the reverse conversion module 95 are arranged along an external bus OB of the CPU 10.

The conversion module 90 has computation functions such as multiplication and addition functions as described in the above embodiments. The conversion module 90 mainly reduces the processing load on the CPU 10 by aiding or assisting the writing of the table values of the LUT 51 of the first macro 41 and the LUT 52 of the second macro 42 to the converted table values. When converting and writing a table value, the CPU 10 reads the table value TB from the reference table memory STM of the ROM 30 and provides the read table value TB to the conversion module 90. Before providing the table value, the CPU 10 sets converter parameters in the conversion module 90 through the setting signal SS. Examples of the conversion parameters include a multiplication value M and an addition constant A.

The conversion module 90 executes correction computation on the provided table value TB based on the set conversion parameters and outputs the corrected table value CTB to the LUT of a specific macro designated by the CPU 10 of the macros 40. The LUT of the macro is thereby updated, that is, rewritten by the corrected table value CTB.

The reverse conversion module 95 has computation functions (division and subtraction) that are opposite the computation functions of the conversion module 90. The reverse conversion module 95 mainly reverse-converts the corrected table value CTB to the reverse conversion table value TBa representing the table value TB before correction when the CPU 10 reads the corrected table value CTB from the LUTs 51 and 52.

The reading of the corrected table value CTB from the LUTs 51 and 52 will now be described. When the CPU 10 reads the corrected table value CTB from the LUT 51 or the LUT 52 commonly connected to the external bus OB, the corrected table value CTB is input to the CPU 10 through the reverse conversion module 95. Before the reading, the CPU 10 sets reverse conversion parameters for the reverse conversion process of the corrected table value CTB in the reverse conversion module 95 through the setting signal SS. Examples of reverse conversion parameters include a division constant (division value) N and a subtraction constant (subtraction value) B. The reverse conversion parameters may be registered in a register of the reverse conversion module 95. The division constant N and the subtraction constant B are set so as to take the same value as the multiplication value M and the addition constant A, respectively, which are conversion parameters set in the conversion module 90. That is, the multiplication value M is the division constant N, and the addition constant A is the subtraction constant B.

The reverse conversion module 95 generates a reverse conversion table value TBa corresponding to the table value TB before correction by subjecting the provided table value CTB to the reverse conversion process based on the set reverse conversion parameters. Then, the reverse conversion module 95 outputs the reverse conversion table value TBa to the CPU 10.

The reverse conversion module 95 does not perform reverse conversion on the table value TB when the CPU 10 reads the table TB from the ROM 30 and directly outputs the table value TB to the CPU 10.

A correction computation circuit that converts table values arranged in the conversion module 90 of the table value conversion device will now be described with reference to FIG. 12. The correction computation circuit of the conversion module 90 basically includes a multiplier 91 and an adder 92.

The multiplier 91 receives the table value TB of the reference table memory STM from the CPU 10. The multiplier 91 receives the multiplication value M, which is the conversion parameter set by the setting signal SS from the CPU 10. The multiplier 91 multiplies the table value TB by the multiplication value M to generate a computation value V11 and provides the computation value V11 to the adder 92.

The adder 92 receives the addition constant A, which is the conversion parameter set by the setting signal SS from the CPU 10. The adder 92 adds the addition constant A to the computation value V11 to generate a computation value and outputs the computation value to a predetermined address of the LUT of a specific macro as the corrected table value CTB. The table value of the address designated by the CPU 10 is thus rewritten to the corrected table value CTB.

In this manner, the conversion module 90 generates the table value CTB by subjecting the table value TB of the reference table memory STM received from the CPU 10 to the following correction computation.

CTB=TB×M+A (6)

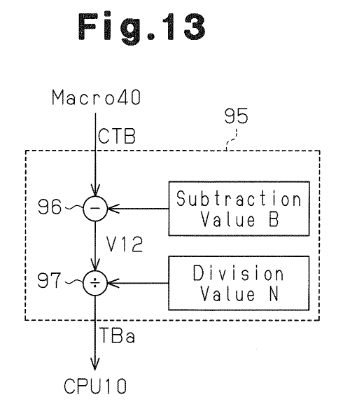

A reverse conversion processing circuit for performing the reverse conversion process arranged in the reverse conversion module 95 of the table value conversion device 200 will now be described with reference to FIG. 13. The reverse conversion processing circuit of the reverse conversion module 95 basically includes a subtractor 96 and a divider 97.

The subtractor 96 receives the subtraction constant B (=addition constant A), which is a reverse conversion parameter set by the setting signal SS from the CPU 10. The subtractor 96 receives the corrected table value CTB of the LUT of the macro designated by the CPU 10. The subtractor 96 subtracts the subtraction constant B from the corrected table value CTB to generate a computation value V12 and provides the computation value V12 to the divider 97.

The divider 97 receives the division constant N (=multiplication value M), which is the reverse conversion parameter set by the setting signal SS from the CPU 10. The divider 97 divides the computation V12 by the division constant N to generate a computation value. The generated computation value is a reverse conversion table value TBa corresponding to the table value TB before correction. The reverse conversion table value TBa is provided to the CPU 10. The CPU 10 thus receives the reverse converted table value TBa generated by reverse converting the corrected table value CTB.

The reverse conversion module 95 generates the table value TB before correction (reverse conversion table value TBa) by subjecting the corrected table value CTB of the LUT of the macro designated by the CPU 10 to the following reverse conversion process.

$$\begin{matrix}TBa = ( C T B - B ) \text{/} N \\ = ( C T B - A ) \text{/} M \\ = TB\end{matrix}$$

The fourth embodiment has the advantage described below in addition to advantages (1), (3), and (4) of the first embodiment.

(7) The reverse conversion module 95 generates the reverse conversion table value TBa corresponding to the table value TB before correction by reverse converting the corrected table value CTB read from the LUT of the macro designated by the CPU 10. Then, the reverse conversion module 95 outputs the reverse conversion table value TBa to the CPU 10. The reverse conversion module 95 matches the table value TB output as write data from the CPU 10 and the reverse conversion table TBa input to the CPU 10 as read data. Therefore, even if the CPU 10 is an in-circuit emulator (ICE), which determines a write error when the write data and the read data do not match, write error determination is avoided since the write data and the read data match. The ICE is used to perform software debugging and hardware operation check and is essential in the development of the built-in system.

In the first to fourth embodiments, multipliers 21, 91, and adders 22, 73, 84, 92 are examples of a first computer. In first to fourth embodiments, the subtracter 71, 81, multipliers 72, 82, and adders 83 are examples of a second computer.

The first to fourth embodiments may be modified as below.

In the table value conversion and writing method of the first to the fourth embodiments, the table values TB are sequentially read from the addresses of the ROM 30 one after another, and the read table values TB (more accurately, the corrected table values CTB) are sequentially written one after another to the addresses of the LUT in the designated macro, e.g., the LUT 51 in the first macro 41. However, the aforementioned embodiment is not limited to such a method. For example, table values TB within a specific address range may be sequentially read one after another, and the table values TB in the specific address range may be corrected and written to the corresponding addresses of the LUT in the designated macro. When all the table values do not need to be rewritten, that is, when only table values in a certain address range need to be rewritten, this method shortens the time taken for the table value conversion and writing for the LUT.

In the first to fourth embodiments, the conversion modules 20, 70, 80, 90 perform correction computations of multiplication and addition on the table value TB but may perform other correction computations such as subtraction and division. In such a case, it is desirable that the reverse conversion module 95 of the fourth embodiment be changed as required to perform the computation opposite the correction computation of the conversion module 90.

In the first embodiment, the correction computation performed by the conversion module 20 includes multiplication, addition, and clipping of the table value TB output from the CPU 10. However, the aforementioned embodiment is not limited in such a manner. For example the correction computation from which clipping is eliminated may be performed, or the correction computation only including either multiplication or addition may be performed.

The conversion modules 70 and 80 of the second and third embodiments may include a clip circuit 23 of the conversion module 20 of the first embodiment.

In the conversion modules 70 and 80 of the second and third embodiments, the type of correction computations performed on the address Addr input from the CPU 10 is not particularly limited.

The assignment of addresses in the second and third embodiments is not particularly limited to the address map shown in FIG. 6.

In the second and third embodiments, the reference address RA is set so that the corrected value C1 becomes “0” when the head address of the LUT of each macro 40 is input to the conversion modules 70 and 80 as the address Addr, but is not limited thereto. For instance, the offset in the positive direction or the negative direction may be set to the address of the LUT by setting the reference address RA such that the corrected value C1 becomes “+X (X: integral number)” or “−X” when the head address of the LUT of each macro 40 is input as the address Addr.

In the second embodiment, the corrected value C2 is generated based on the multiplication value M, which is the conversion parameter, and the address Addr input from the CPU 10. Further, the correction computation (addition) is performed on the table value TB in accordance with the corrected value C2. The aforementioned embodiment is not limited in such a manner, and the multiplication value M, which is the conversion parameter, may be used as the corrected value in the correction computation on the table value TB. The corrected value C1 generated based on the address Addr input from the CPU 10 and the reference address RA may be used as the corrected value in the correction computation on the table value TB.

The reference address RA in the second and third embodiments may be omitted. In this case, the address Addr input to the conversion modules 70 and 80 from the CPU 10 may be used to generate the corrected value C2. Alternatively, the address Addr input from the CPU 10 to the conversion modules 70 and 80 may be used as the corrected value in the correction computation on the table value TB.

In the third embodiment, the entire LUT is divided into three regions of R1, R2, and R3. However, the number of the divided regions is not particularly limited.

The coefficient control circuit 85 of the third embodiment changes the multiplication value M and the addition constant A for every region R1 to R3 as correction coefficients. The aforementioned embodiment is not limited in such a manner, and the coefficient control circuit 85 may change either the multiplication value M or the addition constant A for each of regions R1 to R3.

The conversion modules 20 and 90 and the reverse conversion modules 95 of the first and fourth embodiments may include the coefficient control circuit 85 of the conversion module 80 of the third embodiment. When the conversion module 20 of the first embodiment includes the coefficient control circuit 85, the coefficient control circuit 85 changes the multiplication value M and the addition constant A serving as correction coefficients input to the first computer (multiplier 21 and the adder 22) according to the region to which the address Addr of the LUT belongs.

The first conventional method described in FIG. 1(a) normally requires a plurality of the table memories TM to be prepared in the ROM 60, which is used as a program memory. This increases the memory capacity of the ROM 60. The second conventional method described in FIG. 1(b) requires the CPU 64 to perform a correction computation. This increases the computation load of the CPU 64 and consequently increases the entire processing time required for image processing. The third conventional method shown in FIG. 1(c) requires an exclusive computer for each macro. This requires more computers for more macros, and inevitably increases the production cost of the image processor.

The aforementioned embodiment is directed to simple and efficient rewriting of values stored in a table memory that uses a lookup table.

One aspect of the embodiment is a table value conversion device for use with a memory storing a default table value, a central processing unit for reading the default table value from the memory and outputting an output value, and a functional macro functioning as hardware for processing data and storing a lookup table. The table value conversion device includes an external bus extending between the memory and the central processing unit. A conversion module is arranged on the external bus in which the conversion module receives the output value of the central processing unit, performs a correction computation on the received output value to generate a computation value, and converts a table value of the lookup table in the functional macro based on the computation value.

Another aspect of the embodiment is a method for converting and writing a table value. The method includes arranging a conversion module on an external bus extending between a memory, which stores a default table value, and a central processing unit, which reads the default table value from the memory and outputs an output value. The method further includes receiving the output value of the central processing unit and performing a correction computation on the received output value to generate a computation value with the conversion module, and writing the computation value of the conversion module to a lookup table in a functional macro functioning as hardware for processing data when rewriting a table value of the lookup table.

A further aspect of the embodiment is a digital image processor device including a memory in which a default table value is stored. A central processing unit reads the default table value from the memory and outputs an output value. Functional macros function as hardware for processing data and store a lookup table. An external bus extends between the memory and the central processing unit. A conversion module is arranged on the external bus. The conversion module receives the output value of the central processing unit, performs a correction computation on the received output value to generate a corrected value, and converts a table value of the lookup table in a single one of the functional macros, which is designated by the central processing unit, based on the corrected value.

Other aspects and advantages of the embodiment will become apparent from the following description, taken in conjunction with the accompanying drawings, illustrating by way of example the principles of the embodiment.

It should be apparent to those skilled in the art that the embodiment may be embodied in many other specific forms without departing from the spirit or scope of the embodiment. Therefore, the present examples and embodiments are to be considered as illustrative and not restrictive, and the embodiment is not to be limited to the details given herein, but may be modified within the scope and equivalence of the appended claims.

What is claimed is:

1. A table value conversion device comprising:
an external bus extending between a memory configured to store a default table value and a central processing unit reading the default table value from the memory and outputting an output value; and
a conversion module arranged on the external bus in which the conversion module receives the output value of the central processing unit, performs a correction computation on the received output value to generate a computation value, and converts a table value of the lookup table in a functional macro functioning as hardware for processing data and storing a lookup table based on the computation value.

2. The table value conversion device according to claim 1, wherein the conversion module has a settable conversion parameter and performs the correction computation in accordance with the conversion parameter.

3. The table value conversion device according to claim 2, wherein the conversion parameter of the conversion module includes a multiplication value, an addition value, a lower limit clip value, and an upper limit clip value, and the conversion module performs the correction computation using the equation of:
DATAout=max(L, min(H, DATAin×M+A)),
where M is the multiplication value, A is the addition value, L is the lower limit clip value, H is the upper limit clip value, DATAin is the output value of the central processing unit, DATAout is the computation value output by the conversion module, max(a,b) is a function for selecting the greater one of values a and b, and min(a,b) is a function for selecting the smaller one of values a and b.

4. The table value conversion device according to claim 1, wherein:
the memory and the functional macro are commonly connected to the external bus of the central processing unit via the conversion module;
when the central processing unit reads the default table value from the memory, the conversion module transfers the default table value passing through the external bus to the central processing unit without converting the default table value; and
when the table value of the lookup table in the functional macro is rewritten, the conversion module performs the computation process on the output value of the central processing unit passing through the external bus.

5. The table value conversion device according to claim 1, further comprising:
a reverse conversion module arranged between the functional macro and the central processing unit;
wherein when the central processing unit reads the converted table value from the lookup table, the reverse conversion module reverse-converts the converted table value to a table value before conversion and provides the reverse converted table value to the central processing unit.

6. The table value conversion device according to claim 5, wherein:
the conversion module has a settable conversion parameter and performs the correction computation in accordance with the conversion parameter; and
the reverse conversion module has a reverse conversion parameter corresponding to the conversion parameter and performs the reverse conversion in accordance with the reverse conversion parameter.

7. The table value conversion device according to claim 5, wherein:
the reverse conversion module is arranged on the external bus;
the memory and the functional macro are commonly connected to the external bus of the central processing unit via the reverse conversion module; and
when the central processing unit reads the default table value from the memory, the reverse conversion module transfers the default table value passing through the external bus to the central processing unit without converting the default table value.

8. The table value conversion device according to claim 1, wherein:
the central processing unit designates one of the plurality of functional macros as a write destination functional macro and designates a predetermined address of a lookup table in the write destination function macro as a write destination address;
the computation value is written to the write destination address of the write destination functional macro; and
the conversion module receives the write destination address from the central processing unit, generates a corrected value in accordance with at least one of the conversion parameter and the write destination address, and executes the correction computation in accordance with the corrected value.

9. The table value conversion device according to claim 8, wherein the conversion module subtracts a reference address from the write destination address, and converts the write destination address to an address of the lookup table of the functional macro designated by the central processing unit.

10. The table value conversion device according to claim 9, wherein the reference address is a head address of the lookup table of the write destination functional macro.

11. The table value conversion device according to claim 1, wherein:
the central processing unit designates one of the plurality of functional macros as a write destination functional macro, and designates a predetermined address of a lookup table in the write destination function macro as a write destination address;
the computation value is written to the write destination address of the write destination functional macro;
the lookup table of the write destination functional macro is divided into a plurality of regions; and
the conversion module includes a coefficient control circuit for determining which region of the plurality of regions the write destination address belongs to and setting a correction coefficient corresponding to the region the write destination address belongs to, the correction coefficient being used in the correction computation.

12. The table value conversion device according to claim 1, wherein:
the central processing unit designates one of the plurality of functional macros as a write destination functional macro and designates a predetermined address of a lookup table in the write destination function macro as a write destination address;
the computation value is written to the write destination address of the write destination functional macro;
the lookup table of the write destination functional macro is divided into a plurality of regions; and
the conversion module includes a coefficient control circuit for determining which region of the plurality of regions the write destination address belongs to and setting a correction coefficient corresponding to the region to the write destination address belongs to, the correction coefficient being used to generate the corrected value.

13. A method for converting and writing a table value, the method comprising:
arranging a conversion module on an external bus extending between a memory which is configured to store a default table value and a central processing unit which reads the default table value from the memory and outputs an output value;
receiving the output value of the central processing unit and performing a correction computation on the received output value to generate a computation value with the conversion module; and
writing the computation value of the conversion module to a lookup table in a functional macro functioning as hardware for processing data when rewriting a table value of the lookup table.

14. The method according to claim 13, further comprising:
setting a conversion parameter for the conversion module used to perform the correction computation; and
determining the computation value written to the lookup table as a value corresponding to the conversion parameter.

15. The method according to claim 14, wherein:
the conversion parameter includes a multiplication value, an addition value, a lower limit clip value, and an upper limit clip value, and the computation is performed using the equation of:
DATAout=max(L, min(H, DATAin×M+A)),
where M is the multiplication value, A is the addition value, L is the lower limit clip value, H is the upper limit clip value, DATAin is the output value of the central processing unit, DATAout is the computation value output by the conversion module, max(a,b) is a function for selecting the greater one of values a and b, and min(a,b) is a function for selecting the smaller one of values a and b.

16. The method according to claim 14, wherein the functional macro is one of a plurality of functional macros, each storing a lookup table, the method further comprising:
setting a conversion parameter for the conversion module, with the conversion parameter corresponding to a lookup table in a designated one of the plurality of functional macros, and then further performing:
(a) reading the default table value for one address from the memory with the central processing unit;
(b) generating an output value written to the lookup table in the designated macro with the central processing unit in accordance with said reading, and generating a computation value by performing a correction computation on the output value based on the conversion parameter with the conversion module; and
(c) writing the computation value at a predetermined address of the lookup table in the designated macro;
wherein an address of the memory from which the table value is read and an address of the lookup table in the designated macro to which the table value is written are incremented while repeating the reading the default table value, the generating an output value, and the writing the corrected value until the conversion of each table value in the lookup table is completed.

17. A digital image processor device, comprising:
a memory configured to store a default table value;
a central processing unit for reading the default table value from the memory and outputting an output value;
functional macros functioning as hardware for processing data and each storing a lookup table;
an external bus extending between the memory and the central processing unit; and
a conversion module arranged on the external bus, wherein the conversion module receives the output value of the central processing unit, performs a correction computation on the received output value to generate a corrected value, and converts a table value of the lookup table in a single one of the functional macros, which is designated by the central processing unit, based on the corrected value.

18. The digital image processor device according to claim 17, which is an electronic camera, a digital copying machine, or a laser printer.
